(19) United States
(12) Patent Application Publication
(10) Pub. No.: US 2015/0233640 A1
(43) Pub. Date: Aug. 20, 2015

(54) Blast Furnace Spool Liner

(71) Applicant: GrafTech International Holdings Inc., Independence, OH (US)

(72) Inventors: Richard H Pugh, Selby (GB); Jeffrey D Toth, Lawrenceburg, TN (US)

(21) Appl. No.: 14/420,573

(22) PCT Filed: Aug. 7, 2013
(86) PCT No.: PCT/US13/53939

§ 371 Date: Feb. 9, 2015

Related U.S. Application Data
(60) Provisional application No. 61/681,240, filed on Aug. 9, 2012.

(51) Int. Cl. F27B 1/14; C21B 7/06; F23M 5/00

(52) U.S. Cl. CPC F27B 1/14; F23M 5/00; C21B 7/06

(57) ABSTRACT

A hearth refractory assembly is provided to improve gas sealing of a blast furnace hearth. The blast furnace hearth has a metal outer shell and a spool extending outwardly therefrom. The spool has a spool metal outer wall and forms an opening in said hearth metal outer shell. The refractory liner assembly includes a plurality of hearth refractory bricks arranged in a stacked configuration and lining the interior of the hearth metal outer shell and the spool. A liner is positioned between the hearth refractory brick and said hearth metal outer shell or within the spool and covers substantially all of the spool opening. The liner is a sheet made substantially from graphite.

This application claims priority to International Application No. PCT/US2013/053939 filed Aug. 7, 2013, entitled Blast Furnace Spool Liner, which claims the benefit of U.S. Provisional Application 61/681,240 filed Aug. 9, 2012, entitled Blast Furnace Spool Liner, both of which are hereby incorporated herein by reference in their entirety.

### BACKGROUND

A blast furnace is a form of metallurgical furnace used for smelting to produce industrial metals, most commonly iron. The furnace operates by continuously supplying fuel, ore, and flux through the top of the furnace, while air and/or oxygen is blown into the bottom of the chamber, so that the chemical reactions take place as the material moves from the top to the bottom of the furnace. The process produces molten metal and slag phase, each of which are tapped from the bottom of the furnace.

The blast furnace structure generally includes a metal outer shell with an interior refractory lining. The molten metal and slag is periodically removed from the furnace via tap holes that are drilled through the spool and refractory lining. Due top-pressure within the furnace, the iron will flow up and out the tap hole when it is opened. After the tapping process is complete refractory clay is injected into the tap hole. The refractory clay solidifies and functions to seal the tap hole until molten metal is again removed by drilling the tap hole.

A well-sealed tap hole is important for both furnace efficiency as well as safety. Thus it is important that the refractory clay is properly applied in the tap hole after the tapping process is complete. However, when the tap hole is closed, the hot gasses within the furnace may continue to seek the path of least resistance out of the furnace. The spool is prone to gas leakage and thus, there is a need in the art to provide an improved seal in the area of the blast furnace spool.

### SUMMARY OF THE INVENTION

According to one aspect, a hearth refractory assembly is provided for a blast furnace hearth having a hearth metal outer shell and a spool extending outwardly from the hearth metal outer shell. The spool includes a spool metal outer wall and forms a spool opening in the hearth metal outer shell. The refractory liner assembly includes a plurality of hearth refractory bricks arranged in a stacked configuration that line the interior of the hearth metal outer shell. A liner is positioned between the hearth refractory brick and the hearth metal outer shell and is positioned to cover substantially the entire spool opening. The liner is a sheet made substantially from graphite.

According to another aspect, a hearth refractory assembly is provided for a blast furnace hearth having a hearth metal outer shell and a spool extending outwardly from the hearth metal outer shell. The spool includes a spool metal outer wall and forms a spool opening in the hearth metal outer shell. The refractory liner assembly includes a plurality of spool refractory bricks arranged in a stacked configuration and positioned within the spool metal outer wall. A liner is positioned inside the spool, generally perpendicular to the hearth metal outer shell. The liner has opposed major surfaces and at least one surface engages the spool refractory brick. The liner is positioned and sized to cover substantially the entire spool opening. The liner is a sheet made substantially from graphite.

### DESCRIPTION OF THE DRAWINGS

FIG. 1 is a schematic view of a blast furnace.

FIG. 2 is a partial schematic view of the hearth wall and spool section of a blast furnace including the liner of the present invention.

FIG. 3 is a front view of a spool including a liner.

FIG. 4 is a front view of a spool wherein the liner is positioned within the hearth.

### DETAILED DESCRIPTION

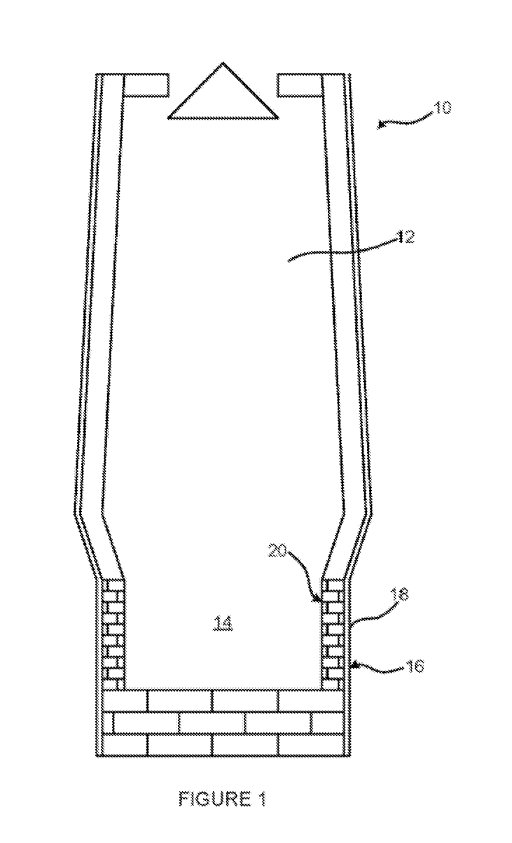

With reference now to FIG. 1, a blast furnace is shown and generally indicated by the numeral 10. Furnace 10 includes an upper shaft 12 through which the raw materials fall and through which the hot gas rises. The hearth 14 is at the bottom portion of blast furnace 10 where the processed molten iron and slag accumulates. A hearth side wall 16 includes an outer metal shell 18 and an inner lining 20 of made stacked hearth refractory brick 22.

The refractory brick may advantageously be rectangular in profile. In one embodiment, a bricks have a volume greater than about 5,900 cm³. In other embodiments, the brick has a volume greater than about 8,900 cm³. In still other embodiments, the brick has a volume greater than about 11,900 cm³. In still other embodiments the brick volume may be from about 4,000 cm³ to about 13,000 cm³. In one embodiment, the height of the brick may between about 7.5 and about 15.0 cm. In one embodiment, the width of the brick may be between about 17.5 cm and about 27.5 cm. In one embodiment, the length of the brick may be from between about 20 cm to about 50 cm.

The refractory bricks are advantageously made predominately of carbon based materials. The refractory brick may be made by carbonizing a green form made from a combination of input materials including, for example, binder pitch and one or more of coke, baked coal, carbon dust, recycled brick scrap materials, graphite powder, semi-graphitized coke. In one embodiment the refractory brick is made of a carbon based material. In these or other embodiments the refractory brick is at least 50 percent carbon, still more preferably at least 70 percent carbon and still more preferably 80 percent carbon. In one or more embodiments the refractory brick is graphite based. It should be appreciated that, though the present embodiment includes primarily carbonaceous refractory brick, other refractory brick may be used. For example, alumina ceramic refractory bricks or ceramic castable refractory bricks may be used. Indeed, combinations of primarily carbonaceous and primarily ceramic refractory bricks may be employed.

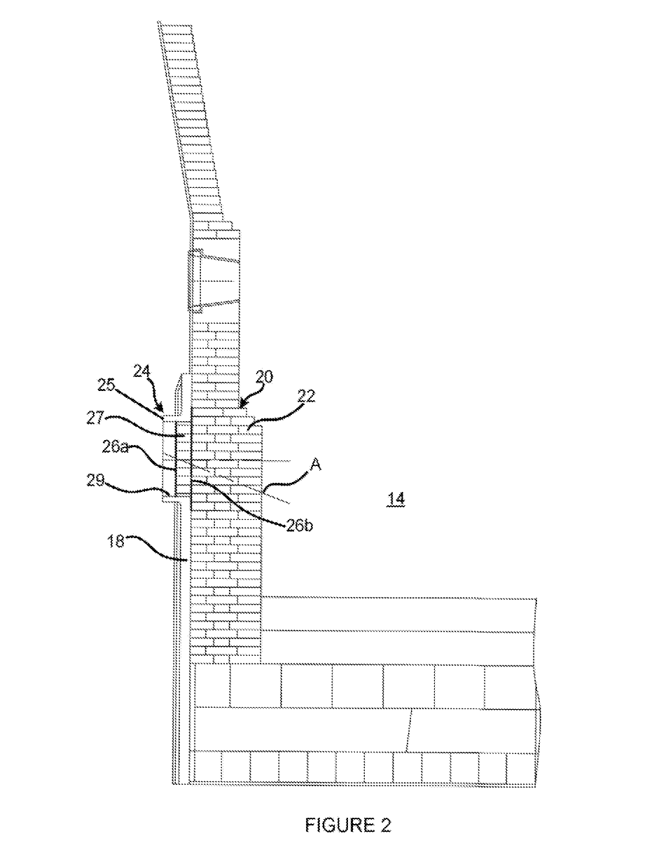

With reference now to FIG. 2, hearth 14 includes a spool 24 that extends outwardly from the hearth sidewall 16. Commonly, spool 24 extends outwardly perpendicular to the hearth sidewall 16 and includes a metal outer wall 25 and one or more layers of stacked spool refractory brick 27. The spool 24 functions as a bridge from the furnace hearth 14 to a main iron trough (not shown) where the tapped molten iron is collected. The spool 24 prevents molten iron from running down the exterior metal shell 18 of hearth 14 as it exits the furnace. Though spool 24 commonly extends perpendicular from the cylindrical hearth 14, the tap hole is typically drilled along a tap hole axis A that is positioned at an angle relative to the spool 24.

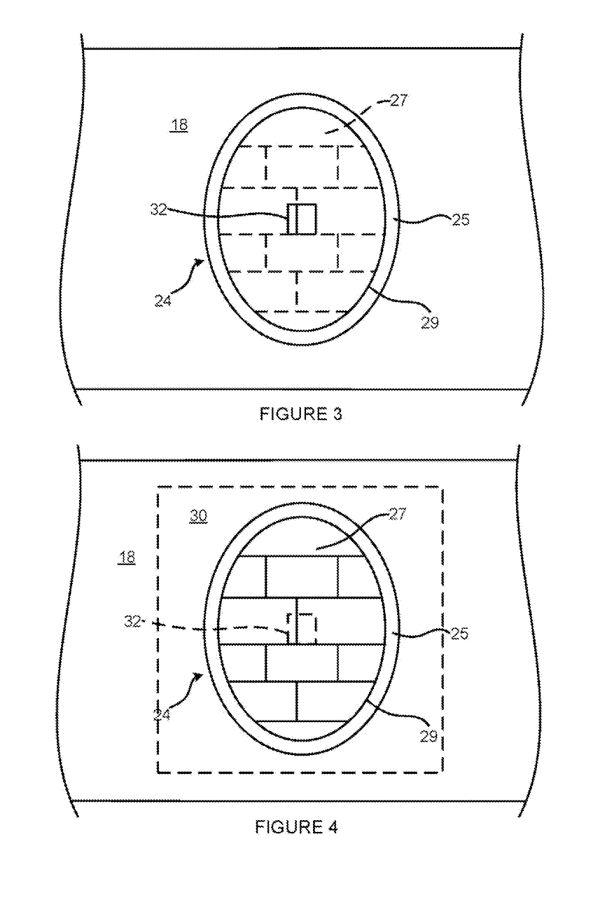

In order to prevent or minimize the release of gasses through seams in the spool refractory brick 27 at spool 24, a liner 26a and/or 26b may be provided. Both liners 26a and 26b are shown in their relative positions in FIG. 2. FIG. 3 shows a view facing the open end of spool 24 in an embodiment including only liner 26a. FIG. 4 shows a view facing the open end of spool 24 in an embodiment including only liner 26b. Liner 26a is positioned outside the hearth 14 but inside the spool 24. In this embodiment, the liner 26a is cut to match the profile of the interior spool opening 29. The interior spool opening 29 may be in any number of shapes. For example, in one embodiment the spool 24 may have a generally rectangular interior spool opening 29 facing the hearth 14. In other furnaces, shown in FIGS. 3 and 4, the spool 24 has a generally oval interior spool opening 29 facing the hearth 14. Liner 26a may be installed as shown in FIG. 2, oriented generally parallel to the hearth wall 16 at the outer face of the stacked spool refractory bricks 27 and extend to the spool metal walls 25 to cover the entire spool opening 29. In another embodiment, the liner 26a may be positioned within the spool 24 and be secured between spool refractory bricks 27 positioned both inwardly (relative to the hearth wall 16) and outwardly therefrom. Thus according to this embodiment, both opposed major surfaces of liner 26a contact the spool refractory bricks 27. In other words, the liner 26a may be sandwiched between spool refractory bricks 27. In accordance with this embodiment, the liner 26a may be adhered to the spool metal wall 25 and/or to spool refractory bricks 27 with an appropriate adhesive. In this or other embodiments, a flange (not shown) may extend inwardly (relative to the centerline of spool 24) circumferentially around spool 24. In this manner, liner 26a may overlap and contact the flange to improve gas sealing as well as provide a surface with which to adhere liner 26a.

With reference now to FIGS. 2 and 4, liner 26b is also positioned to improve gas sealing, however, instead of being positioned within spool 24, liner 26b may be positioned inside hearth wall 16, overlapping the area of spool opening 29 and between the metal outer wall 18 and inner lining 20. In other words, a first major surface of liner 26b engages the hearth refractory bricks 22 and at least a portion of the second major surface contacts the metal outer wall 18. According to such an embodiment, the liner 26b has an outer profile (i.e. length and width) that is advantageously larger than the spool opening 29. Thus, at least a portion 30 of the liner 26b overlaps the metal outer wall 18 to ensure effective gas sealing. It should be appreciated that furnace 10 may include only liner 26a, only liner 26b or both liners 26a and 26b.

Liner 26 includes a central aperture 32, through which the tap hole is drilled. In the Figures the aperture is shown as square shaped, however, other shapes are envisioned such as, for example, circular or oval. In still other embodiments, the liner 26 is installed without an aperture and it is subsequently formed after installation when the tap hole is drilled.

Liner 26 may be thin (relative to the length and width) and sheet-like, having two opposed major surfaces. Liner 26 is advantageously formed of a sheet of a compressed mass of exfoliated graphite particles, a sheet of graphitized polyimide or combinations thereof. In one embodiment, each graphite sheet may be between about 0.1 mm and about 3 mm thick. In other embodiments, the graphite sheet may be between about 0.5 mm and about 2 mm. In other embodiments the graphite sheet may be less than about 2.0 mm thick. In one embodiment, the liner 26 may be formed a single graphite sheet. In other embodiments, a plurality of graphite sheets may be laminated together to form liner 26. Thus, in one embodiment liner 26 may be laminated and have a thickness from between about 1.0 mm to about 10 mm.

The graphite sheet which forms the liner 26 layer may be anisotropic and have an in-plane thermal conductivity of greater than about 150 W/mK at about room temperature (using the Angstrom method to test at room temperature being approximately 25° C.). In another embodiment the in-plane thermal conductivity of the graphite sheet is at least about 250 W/mK. In yet a further embodiment, the in-plane thermal conductivity of the graphite sheet may be at least about 550 W/mK. In additional embodiments, the in-plane thermal conductivity may range from at least 150 W/mK to about 1500 W/mK. In still further embodiments, the in-plane thermal conductivity may range from about 250 W/mK to about 700 W/mK. In another embodiment, the thru-plane thermal conductivity of the graphite sheet may be from between about 1 W/mK and about 20 W/mK. In this or other embodiments, the thru-plane thermal conductivity is from between about 2 W/mK and about 6 W/mK. In other embodiments, the thru-plane thermal conductivity is from between about 14 W/mK and about 18 W/mK. In one embodiment, the graphite sheet may have a density from between about 0.1 grams per cubic centimeter to about 2.0 grams per cubic centimeter. In other embodiments, the graphite sheet may have a density from between about 0.8 grams per cubic centimeter to about 1.6 grams per cubic centimeter. Furthermore, each graphite sheet (if more than one are used) may have the same or different in-plane thermal conductivities, densities and/or thicknesses. Suitable graphite sheets and sheet making processes are disclosed in, for example, U.S. Pat. Nos. 5,091,025 and 3,404,061, the contents of which are incorporated herein by reference.

The various embodiments described herein can be practiced in any combination thereof. The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims.

What is claimed:

1. A hearth refractory assembly for a blast furnace hearth having a hearth metal outer shell and a spool extending outwardly from the hearth metal outer shell, the spool including a spool metal outer wall and forming a spool opening in said hearth metal outer shell, the refractory liner assembly comprising:
a plurality of hearth refractory bricks arranged in a stacked configuration and lining the interior of said hearth metal outer shell; and
a liner positioned between said hearth refractory brick and said hearth metal outer shell and positioned to cover substantially all of said spool opening, said liner being a sheet made substantially from graphite.

2. The hearth refractory assembly according to claim 1 wherein said liner comprises a compressed mass of exfoliated graphite particles.

3. The hearth refractory assembly according to claim 1 wherein said liner is from between about 0.1 mm and about 3 mm thick.

4. The hearth refractory assembly according to claim 1 wherein said liner includes an aperture aligned with a tap hole axis though which a tap hole is drilled.

5. The hearth refractory assembly according to claim 1 wherein said liner has a density from between about 0.1 grams per cubic centimeter to about 2.0 grams per cubic centimeter.

6. The hearth refractory assembly according to claim 1 wherein said hearth refractory brick is made substantially from carbon material.

7. A hearth refractory assembly a blast furnace hearth having a hearth metal outer shell and a spool extending outwardly from the hearth metal outer shell, the spool including a spool metal outer wall and forming a spool opening in said hearth metal outer shell, the refractory liner assembly comprising:
a plurality of spool refractory bricks arranged in a stacked configuration and positioned within said spool metal outer wall; and
a liner positioned inside said spool, generally perpendicular to said hearth metal outer shell, having opposed major surfaces wherein at least one surface engages said spool refractory brick and positioned to cover substantially all of said spool opening, said liner being a sheet made substantially from graphite.

8. The hearth refractory assembly according to claim 7 wherein said liner comprises a compressed mass of exfoliated graphite particles.

9. The hearth refractory assembly according to claim 7 wherein said liner is from between about 0.1 mm and about 3 mm thick.

10. The hearth refractory assembly according to claim 7 wherein said liner includes an aperture aligned with a tap hole axis though which a tap hole is drilled.

11. The hearth refractory assembly according to claim 7 wherein said liner has a density from between about 0.1 grams per cubic centimeter to about 2.0 grams per cubic centimeter.

12. The hearth refractory assembly according to claim 7 wherein said spool refractory brick is made substantially from carbon material.

13. The hearth refractory assembly according to claim 7 wherein the other of said liner opposed major surfaces engages said spool refractory brick.

14. A method of installing a liner in a blast furnace hearth having a hearth metal outer shell and a spool extending outwardly from the hearth metal outer shell, the spool including a spool metal outer wall and forming a spool opening in said hearth metal outer shell, the method comprising:
positioning a graphite liner to cover substantially all of said spool opening, said liner being contiguous with no apertures;
installing refractory bricks in said spool and on the interior of said hearth metal outer shell;
drilling a tap hole through said refractory bricks along a tap hole axis extending through said spool to form an aperture in said liner.

15. The method according to claim 14 wherein said liner comprises a compressed mass of exfoliated graphite particles.

16. The method according to claim 14 wherein said liner is from between about 0.1 mm and about 3 mm thick.
